(19) United States
(12) Patent Application Publication
(10) Pub. No.: US 2025/0348031 A1
(43) Pub. Date: Nov. 13, 2025

(54) IMAGE FORMING APPARATUS

(71) Applicant: KYOCERA Document Solutions Inc., Osaka-shi, Osaka (JP)

(72) Inventor: Susumu TANIGUCHI, Osaka (JP)

(21) Appl. No.: 18/871,661

(22) PCT Filed: Jun. 6, 2023
(86) PCT No.: PCT/JP2023/020974

§ 371 Date: Dec. 4, 2024

(30) Foreign Application Priority Data
Jun. 10, 2022 (JP) 2022-094314

(51) Int. Cl. G03G 15/00; G03G 15/20; G03G 21/02

(52) U.S. Cl. CPC G03G 15/50; G03G 15/2017; G03G 15/2064; G03G 15/657; G03G 21/02; G03G 2215/2035

(57) ABSTRACT

An image forming apparatus (2) includes a fixing belt (240), a heater (241), a pressure roller (242), a fixing motor (243), a temperature sensor (244), an expansion amount estimating section (34), and a fixing motor controller (246). The fixing belt (240) fixes a toner image on a sheet S. The heater (241) heats the fixing belt (240). The pressure roller (242) applies pressure to the fixing motor (243). The fixing motor (243) drives the pressure roller (242). The temperature sensor (244) measures a temperature of the heater (241). The expansion amount estimating section (34) estimates an expansion amount based on a relationship between a temperature of the heater (241) and an expansion amount of the pressure roller (242). The fixing motor controller (246) performs control of driving the fixing motor (243) based on the expansion amount of the pressure roller (242).

### TECHNICAL FIELD

The present invention relates to an image forming apparatus.

### BACKGROUND ART

Patent Literature 1 discloses a fixing device that controls a linear velocity of pressure rollers based on the temperature of a heat roller.

### CITATION LIST

### Patent Literature

Patent Literature 1
JPH02289860 (A)

### SUMMARY OF INVENTION

### Technical Problem

Patent Literature 1 however fails to disclose an image forming apparatus that estimates an expansion amount of the pressure rollers and then controls the linear velocity of the pressure rollers.

An object of the present invention is to provide an image forming apparatus that is capable of estimating an expansion amount of a pressure roller for driving a fixing belt in a rotational manner and then controlling a linear velocity of the pressure roller.

### Solution to Problem

An image forming apparatus according to an aspect of the present invention includes a fixing member, a heater, a pressure member, a fixing motor, a temperature detector, an expansion amount estimating section, and a controller. The fixing member fixes a toner image on a sheet. The heater heats the fixing member. The pressure member applies pressure to the fixing member to form a nip. The fixing motor drives the pressure member. The temperature detector measures a temperature of the heater. The expansion amount estimating section estimates an expansion amount based on a relationship between the temperature and an expansion amount of the pressure member. The controller performs control of driving the fixing motor based on the expansion amount.

### Advantageous Effects of Invention

Approach by the image forming apparatus according to the present invention enables control of a linear velocity of a pressure roller for driving a fixing belt in a rotational manner with an expansion amount of the pressure roller being estimated.

### BRIEF DESCRIPTION OF DRAWINGS

FIG. 1 is a diagram illustrating a multi-function peripheral including an image forming apparatus according to an embodiment of the present invention.

FIG. 2 is a block diagram of components that perform control on a fixing section of the image forming apparatus.

FIG. 3 is a block diagram of components that perform a basic process of the image forming apparatus.

FIG. 4 is a flow chart illustrating a basic process of the image forming apparatus.

FIG. 5 is a flow chart illustrating an embodiment of the image forming apparatus.

FIG. 6 is a table depicting a relationship between heater temperatures and control amounts of a fixing motor for each type of paper.

### DESCRIPTION OF EMBODIMENTS

An embodiment of the present invention will be described below with reference to the drawings. Elements that are the same or equivalent are labelled with the same reference signs in the drawings and description thereof is not repeated. In the embodiments, the drawings include an X-axis, a Y-axis, and a Z-axis that are orthogonal to each other. The Z-axis is parallel to the vertical plane, and the X and Y axes are parallel to the horizontal plane.

In an image forming section 23 of the embodiment, a Z-axis direction, which is a conveyance direction of a sheet S, may be described as a sub-scanning direction. A Y-axis direction may be described as a main scanning direction. An X-axis direction may be described as a direction intersecting the main scanning direction and the sub-scanning direction.

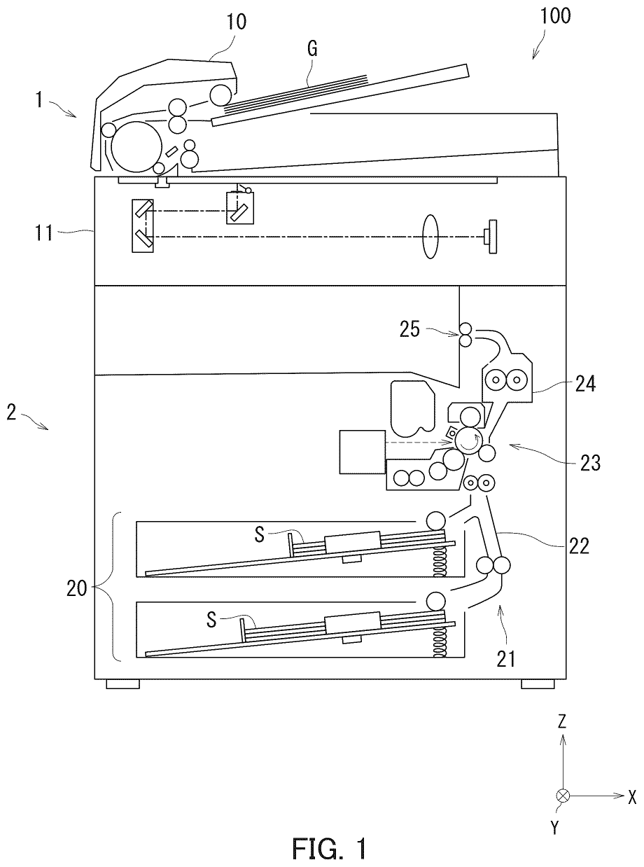

A multi-function peripheral 100 will be described with reference to FIGS. 1, 2, and 6. Here, the multi-function peripheral 100 includes an image forming apparatus 2 according to an embodiment of the present invention.

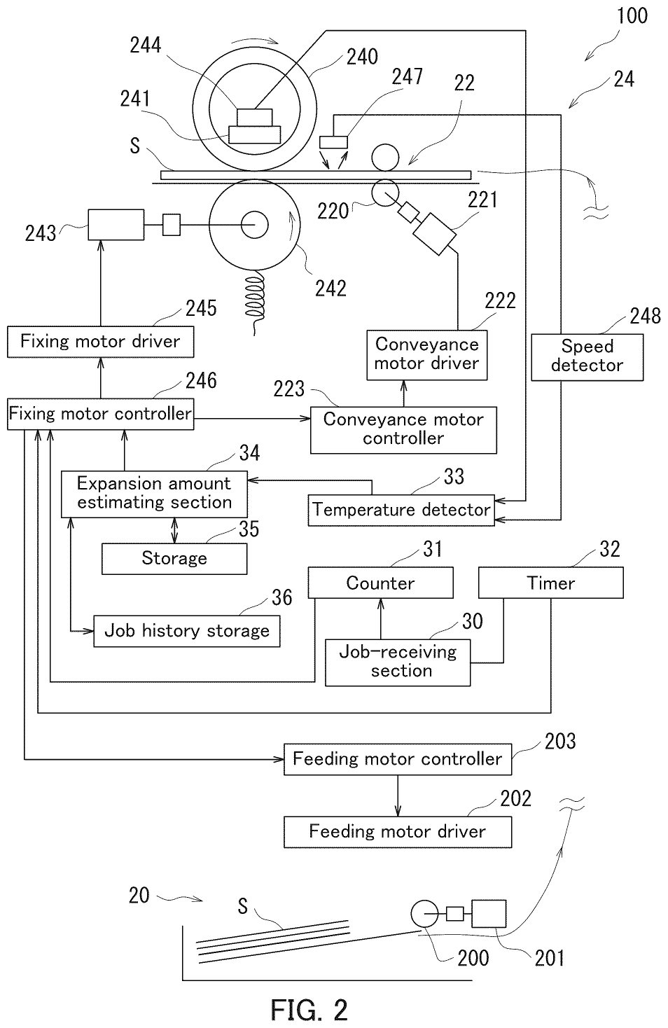

FIG. 2 is a block diagram of components that perform control on a fixing section 24 of the image forming apparatus 100. In FIG. 2, a feeding path 21, a conveyance section 22, and the image forming section 23 are omitted in order to facilitate preparation of the drawings. Here, the feeding path 21, the conveyance section 22, and the image forming section 23 are intermediate between a feeding section 20 and a fixing section 24, which will be described later with reference to FIG. 1.

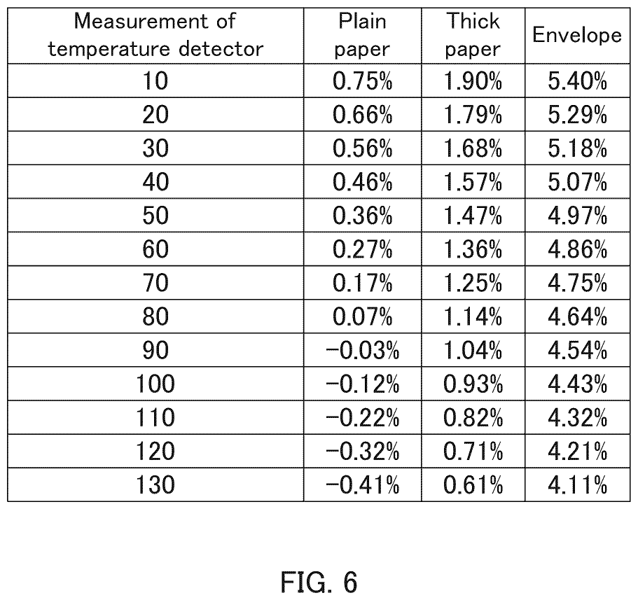

FIG. 6 is a table depicting a relationship between heater temperatures and control amounts of a fixing motor for each type of paper.

A configuration of the image forming apparatus 100 will be described with reference to FIG. 1. The image forming apparatus 100 may be the multi-function peripheral 100.

The multi-function peripheral 100 is, for example a multi-function printer (MFP) which incorporates functions such as scanner, copier, printer, facsimile, as well as other functions. The multi-function peripheral 100 is, for example a multi-function peripheral that incorporates copier function, facsimile function, or these functions. Hereinafter, the multi-function peripheral 100 will be referred to as the image forming apparatus 100 in principle.

As depicted in FIG. 1, the image forming apparatus 100 includes a document reading apparatus 1 and the image forming apparatus 2.

The document reading apparatus 1 includes a document feeder 10 and a document reader 11. The document feeder 10 includes, for example, a document feed tray, a document conveyance section, a document reading section, a document exit section, and a document exit tray. An example of the document feeder 10 is an auto document feeder (ADF).

The document reader 11 includes an optical system. The optical system includes, for example, a light emitter, a lens, a reflector, and a light receiver.

The document reader 11 reads an image from a document G conveyed by the document feeder 10. The document reader 11 generates image data from the read image. An example of the document reader 11 is a contact image sensor (CIS) type or charge-coupled device (CCD) type scanner.

The image forming apparatus 2 includes the feeding section 20, the feeding path 21, the conveyance section 22, the image forming section 23, the fixing section 24, and an ejecting section 25.

The image forming apparatus 2 forms an image on a sheet S.

The feeding section 20 stores sheets S. The feeding section 20 also feeds a sheet S.

As depicted in FIG. 2, the feeding section 20 includes a tray, a feeding roller 200, a feeding motor 201, a feeding motor driver 202, and a feeding motor controller 203. The tray stores sheets S.

The feeding roller 200 picks up and feeds a sheet S on the tray. The sheet S is an example of a recording medium.

The feeding motor 201 drives the feeding roller 200 in a rotational manner.

The feeding motor driver 202 drives the feeding motor 201 in a rotational manner.

The feeding motor driver 202 can be realized by an application specific integrated circuit (ASIC), for example.

The feed motor controller 203 performs control of driving the feeding motor driver 202.

The feeding motor controller 203 may be, for example, a processor such as a central processing unit (CPU). The feeding motor controller 203 may be an integrated circuit such as a system-on-a-chip (SoC) in which other components are integrated. The feeding motor controller 203 may be configured by a combination of multiple integrated circuits.

As depicted in FIG. 1, the feeding path 21 switches between a plurality of feeding sections 20.

The conveyance section 22 conveys a sheet S that has been fed through the feeding section 20 and the feeding path 21. As depicted in FIG. 2, the conveyance section 22 includes a conveyance path, a conveyance roller 220, a conveyance motor 221, a conveyance motor driver 222, and a conveyance motor controller 223.

As depicted in FIG. 1, the conveying path starts at the feeding section 20 and extends to the ejecting section 25 via the feeding path 21, the conveyance section 22, the image forming section 23, and the fixing section 24.

As depicted in FIG. 2, the conveyance roller 220 conveys a sheet S to a fixing member. More than one conveyance roller 220 may be arranged at multiple locations on the conveyance path as necessary. The conveyance roller 220 conveys a sheet fed by the feeding section 20 to the ejecting section 25 via the feeding path 21, the conveyance section 22, the image forming section 23, and the fixing section 24.

The conveyance motor 221 drives the conveyance roller.

The conveyance motor driver 222 drives the conveyance motor 221.

The conveyance motor driver 222 may have a similar configuration to the feeding motor driver 202.

The conveyance motor controller 223 controls the conveyance motor driver 222.

The conveyance motor controller 223 may have a similar configuration to the feeding motor controller 203.

In FIG. 1, the image forming section 23 forms an image on a sheet S using a developer such as toner. The image forming apparatus 100 may be of an electrophotographic type. In this case, the image forming section 23 includes a photosensitive member, a charger, a light exposure device, a development device, a transfer device, a cleaning device, and a static elimination device.

The photosensitive member is, for example a photosensitive drum. The photosensitive drum includes an outer peripheral surface and a photosensitive layer on the outer peripheral surface. Examples of the photosensitive drum include a selenium drum and an organic photoconductor (OPC).

The charger charges the photosensitive layer of the photosensitive member to a predetermined potential. An example of the charger is a corona discharger.

The light exposure device illuminates the photosensitive layer of the photosensitive member with laser light, thereby exposing the photosensitive layer. The light exposure device exposes the photosensitive layer of the photosensitive member based on image data. As a result, an electrostatic latent image is formed on the photosensitive member. The light exposure device includes, for example a light emitting diode (LED).

The development device stores, for example a dual component developer containing a carrier made of a magnetic material and a toner. The development device may store a one-component developer containing toner. The development device then develops the electrostatic latent image formed on the photosensitive member with the toner, thereby forming a toner image on the photosensitive member.

The transfer device transfers the toner image on the photosensitive member to a sheet.

In an example, an indirect transfer type of transfer device includes an intermediate transfer member and a transfer roller. The photosensitive member primarily transfers the toner image onto the intermediate transfer member. The transfer roller drives the intermediate transfer member in a rotational manner to form a nip between the photosensitive member and the intermediate transfer member. The transfer roller secondarily transfers the toner image onto the sheet S that is conveyed to the conveyance section 22.

In another example, a direct transfer type of transfer device includes a conveyance belt disposed in a part of the conveyance section 22 and a transfer roller. The transfer roller urges the conveyor belt against the photosensitive member to form a nip between the conveyor belt and the photosensitive member. The photosensitive member directly transfers the toner image onto the sheet S that is conveyed on the conveyor belt.

The cleaning device removes residual toner remaining on the photosensitive member after transfer.

The static elimination device removes static electricity from the photosensitive member.

As depicted in FIG. 1, the fixing section 24 heats and presses the toner image developed on the sheet S to fix the toner image on the sheet S. As depicted in FIG. 2, the fixing section 24 includes a fixing belt 240, a heater 241, a pressure roller 242, a fixing motor 243, a temperature sensor 244, a fixing motor driver 245, a fixing motor controller 246, a speed sensor 247, and a speed detector 248.

The fixing belt 240 fixes the toner image on the sheet S.

The heater 241 is supplied with electric power from a power supply (not shown) and heats the fixing member. An example of the fixing member is the fixing belt 240 or a fixing roller. In the present embodiment, the fixing member will be described as, for example the fixing belt 240.

The heater 241 can also be described as heating the toner image formed on the sheet S via the fixing belt 240. The heater 241 is arranged close to an inner peripheral surface of the fixing belt 240. The sheet S conveyed to the conveyance section 22 passes through a nip part and is heated by the heater 241, so that the toner image is fixed.

The pressure roller 242 applies pressure to the fixing member to form a nip. That is, the pressure roller 242 is pressed against the fixing belt 240 to apply pressure to the fixing belt 240, thereby forming a nip between the pressure roller 242 and the fixing belt 240.

The fixing motor 243 drives a pressure member. An example of the pressure member is the pressure roller 242. That is, the fixing motor 243 drives the pressure roller 242.

The pressure roller 242 is driven in a rotational manner by the fixing motor 243 with a nip formed between the pressure roller 242 and the fixing belt 240, thereby rotating the fixing belt 240.

Temperature sensor 244 measures the temperature of the heater 241. Examples of the temperature sensor 244 include a thermocouple and a thermistor.

The fixing motor driver 245 drives the fixing motor 243. The fixing motor driver 245 may have the same configuration as the feeding motor driver 202.

The fixing motor controller 246 performs control of driving the fixing motor driver 245. The fixing motor controller 246 may have the same configuration as the feeding motor controller 203.

As depicted in FIG. 2, the speed sensor 247 measures a conveyance speed of the sheet S conveyed to the fixing section 24. The speed sensor 247 is an ultrasonic sensor or a light emitting/receiving sensor using a charge-coupled device (CCD).

The speed detector 248 acquires a conveyance speed of the sheet S measured by the speed sensor 247. The speed detector 248 may be realized by an ASIC.

The ejecting section 25 depicted in FIG. 1 ejects the sheet S outside the casing of the image forming apparatus 100. The ejecting section 25 may include an ejecting roller and an exit tray. The ejecting roller ejects, to the exit tray, the sheet S conveyed by the conveyance roller from the fixing section 24. The sheet S is ejected and then stacked on the exit tray.

As depicted in FIG. 2, the image forming apparatus 100 further includes a job-receiving section 30, a counter 31, a timer 32, a temperature detector 33, an expansion amount estimating section 34, storage 35, and job history storage 36.

The job-receiving section 30, the counter 31, the timer 32, the temperature detector 33, and the expansion amount estimating section 34 may be realized by ASIC.

The job-receiving section 30 receives jobs. The job-receiving section 30 receives, for example, a job for printing characters or image data acquired by reading a document G with the document reading apparatus 1 depicted in FIG. 1. The job-receiving section 30 may receive a job for printing characters or image data acquired from an external terminal (not illustrated).

The counter 31 counts the number of sheets processed according to a job received.

The timer 32 measures an interval from when the fixing member finishes a process for a m-th sheet S to when it starts a process for a (m+1)-th sheet S. Here, m is a natural number.

In a specific example, the image data of a certain job received by the job-receiving section 30 has a data volume for printing 100 sheets S. In addition, m=70, for example. In this case, the interval to be measured is from the end of an image forming process for the 70th sheet S to the start of an image forming process for the 71st sheet S.

In one job, the degree of cooling of the heater 241 differs between a long interval (e.g., 10 minutes) and a short interval (e.g., 5 seconds) each of which is from the end of the image forming process for the 70th sheet S to the start of the image forming process for the 71st sheet S.

An expansion degree (expansion amount) of the pressure roller 242 when the image forming process for the 71st sheet S is started differs from the previous one. As a result, the fixing motor controller 246 needs to control the fixing motor driver 245 in response to respective expansion degrees (expansion amounts) of the pressure roller 242.

The timer 32 may measure an interval from the end of an n-th job (n is a natural number) to the start of a process for an (n+1)-th job.

Specifically, the job-receiving section 30 may receive a plurality of jobs in succession. For example, when n=2, the job-receiving section 30 measures an interval from the end of the second job to the start of the third job.

The degree of cooling of the heater 241 is different between a long interval (e.g., 10 minutes) and a short interval (e.g., 5 seconds), from when finishing a process of the second job and to when starting a process of the third job, in two consecutive jobs.

The pressure roller 242 is therefore to have a different expansion degree (expansion amount) when starting a process of the third job. As a result, the fixing motor controller 246 needs to control the fixing motor driver 245 in response to respective expansion degrees (expansion amounts) of the pressure roller 242.

The temperature detector 33 acquires the temperature of the heater measured by the temperature sensor 244.

The expansion amount estimating section 34 estimates an expansion amount of the pressure member based on the relationship between temperatures of the heater 241 and expansion amounts of the pressure member. That is, the expansion amount estimating section 34 estimates an expansion amount of the pressure roller 242 based on the relationship between the temperatures of the heater 241 and the expansion amounts of the pressure roller 242.

The storage 35 stores a table representing the relationship between the temperatures of the heater 241 and the expansion amounts of the pressure roller 242. The table depicted in FIG. 6 is referred to for the relationship between the temperatures of the heater 241 and the expansion amounts of the pressure roller 242.

The job history storage 36 stores, for sheets S of each job, a conveyance speed history of the sheets S acquired by the speed detector 248 based on respective conveyance speeds of the sheets S measured by the speed sensor 247. The conveyance speed of each sheet S is equal to a linear velocity of the fixing motor 243. The conveyance speed history of the sheets S can be regarded as a linear velocity history of the fixing motor 243. The conveyance speed of each sheet S can be regarded as a corresponding linear velocity of the pressure roller 242.

The table depicted in FIG. 6 represents a relationship between a temperature of the heater 241, which the temperature sensor 244 measures and the temperature detector 33 acquires, and a correction amount of a linear velocity of the pressure roller 242 based on an expansion amount (expansion degree) of a sheet S for each temperature.

The table in FIG. 6 represents, for example, respective correction amounts for three types of sheets S such as plain paper, thick paper, and envelopes for each temperature of the heater 241.

For example, assume that the sheet S and the heater 241 are plain paper and 70° C. in temperature in FIG. 6, respectively. In this case, the expansion amount estimating section 34 estimates that the pressure roller 242 has contracted by 0.17% compared to the pressure roller 242 under normal conditions.

The fixing motor controller 246 controls the fixing motor driver 245 so that the linear velocity of the pressure roller 242 is 0.17% faster than a normal linear velocity thereof.

The temperature of the heater 241 subsequently rises to 130° C. In this case, the expansion amount estimating section 34 estimates that the pressure roller 242 has expanded by 0.41% compared to the pressure roller 242 under normal conditions.

The fixing motor controller 246 controls the fixing motor driver 245 so that the linear velocity of the pressure roller 242 is 0.41% slower than the normal linear velocity.

The same applies to the thick paper and the envelopes.

Control by the fixing motor controller 246 will then be described.

The fixing motor controller 246 performs control of driving the fixing motor 243 based on the expansion amount of the pressure member estimated by the expansion amount estimating section 34.

Approach by the present embodiment enables the pressure roller 242 to drive the fixing belt 240 in a rotational manner at a linear velocity to be controlled by estimating an expansion amount of the pressure roller 242.

The fixing motor controller 246 may perform the control of driving the fixing motor 243 before the counter 31 counts 1.

Approach by this example in the embodiment enables the pressure roller 242 to be controlled at a preferable linear velocity before the counter 31 counts the first sheet S after a corresponding job is received.

The fixing motor controller 246 may determine a linear velocity of the fixing motor 243 in a process for a k-th sheet based on the linear velocity history of the fixing motor 243 in a process for a (k−1)-th sheet before the counter 31 counts the k-th sheet (k is a natural number of 2 or more).

Approach by this example in the embodiment enables the fixing motor 243 to be continuously controlled at a liner velocity based on the linear velocity history of the fixing motor 243 even when the process of the job is progressing.

The fixing motor controller 246 may perform the control of driving the fixing motor 243 based on an interval. That is, the fixing motor controller 246 may perform control of driving the fixing motor 243 based on the interval between a process for a (k−1)-th sheet and a process for a k-th sheet.

Approach by this example in the embodiment enables the fixing motor 243 to be driven under control in response to the length of an interval even if the interval is longer than a predetermined time and occurs during the process of the job.

The fixing motor controller 246 may perform control of driving the fixing motor 243 based on an interval. That is, the fixing motor controller 246 may perform control of driving the fixing motor 243 based on an interval between an n-th job (n is a natural number) and an (n+1)-th job.

Approach by this example in the embodiment enables the fixing motor 243 to be driven under control in response to the length of an interval even if the interval is longer than a predetermined time and occurs between successive jobs.

The fixing motor controller 246 may complete the control of driving the fixing motor 243 before the feeding section 20 starts feeding sheets S.

The fixing motor controller 246 may complete the control of driving the fixing motor 243 at the latest before a sheet S approaches the fixing member.

Approach by this example in the embodiment enables the pressure roller 242 to be controlled at a preferable linear velocity before a sheet S reaches the fixing belt 240.

The fixing motor controller 246 may control a fixing linear velocity of the pressure member to match a conveyance linear velocity of the conveyance roller 220 based on an expansion amount. That is, the fixing motor controller 246 may control the fixing linear velocity of the pressure roller 242 to match the conveyance linear velocity of the conveyance roller 220 based on the expansion amount of the pressure roller 242.

In this example in the embodiment, it is possible to prevent strong tension from occurring in a sheet S, thereby preventing slack from occurring in the sheets S. The quality of a toner image fixed on each sheet S can therefore be improved.

The fixing motor controller 246 may correct the driving the fixing motor 243 based on a relationship between temperatures of the heater 241 and control amounts of the fixing motor 243 for each paper type.

Approach by this example in the embodiment enables the fixing motor 243 to be driven undergoing a suitable correction based on the table stored in the storage 35.

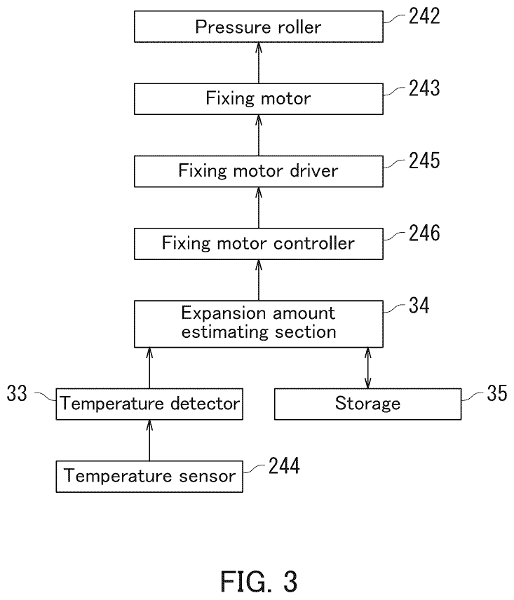

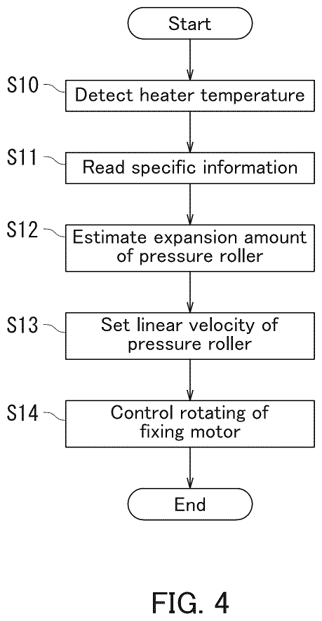

FIG. 3 is a block diagram of components that perform a basic process of an image forming apparatus 100. FIG. 4 is a flow chart depicting the basic process of the image forming apparatus 100.

The basic process of the image forming apparatus 100 will be described with reference to FIGS. 3 and 4. FIG. 3 is a flow chart depicting the basic process of the image forming apparatus 100. As depicted in FIG. 4, the process of the image forming apparatus 100 includes Steps S10 to S14 performed according to process steps based on the block diagram of FIG. 3.

In Step S10 depicted in FIG. 4, the temperature detector 33 acquires a temperature of the heater measured by the temperature sensor 244. The process advances to Step S11.

In Step S11, the expansion amount estimating section 34 reads the relationship (characteristic information) between temperatures of the heater 241 and expansion amounts of the pressure member from the table as described in FIG. 6. The process proceeds to Step S12.

In Step S12, the expansion amount estimating section 34 estimates an expansion amount of the pressure member based on the relationship between temperatures of the heater 241 and expansion amounts of the pressure member. The process proceeds to Step S13.

In Step S13, the fixing motor controller 246 sets a linear velocity of the pressure roller 242. The process proceeds to Step S14.

In Step S14, the fixing motor controller 246 performs control of driving the fixing motor 243.

The fixing motor driver 245 drives the fixing motor 243 in a rotational manner.

The fixing motor 243 drives the pressure roller 242 in a rotational manner.

The pressure roller 242 rotates the fixing belt 240 while applying pressure to the fixing belt 240.

The process then ends.

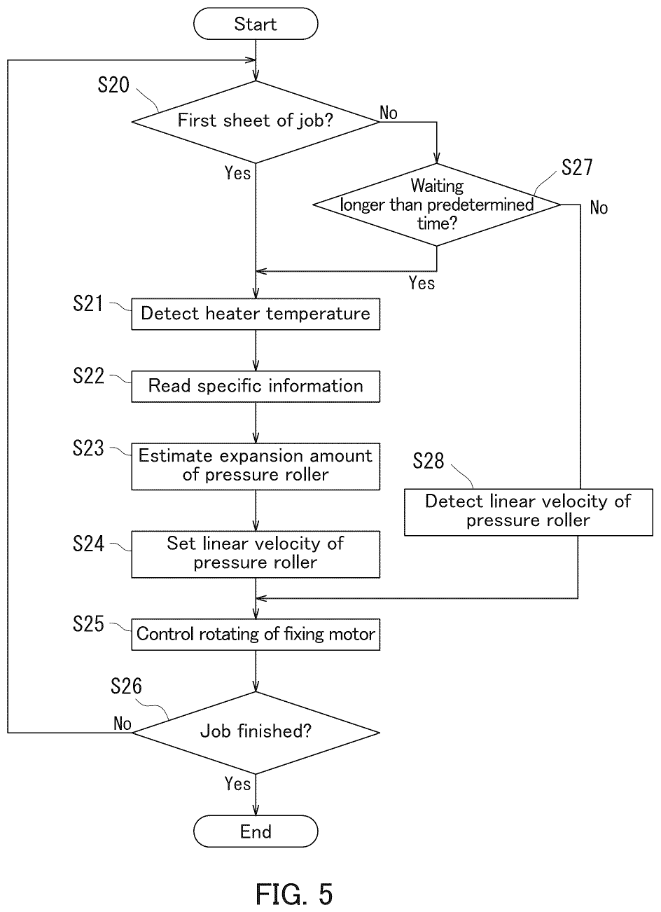

A process by an embodiment of an image forming apparatus 100 will be described with reference to FIG. 5. FIG. 5 is a flow chart depicting the embodiment of the image forming apparatus 100. The process includes Steps S20 to S28 as depicted in FIG. 5.

In Step S20 of FIG. 5, a job-receiving section 30 receives a job. A counter 31 counts the number of sheets S to be processed. A fixing motor controller 246 determines whether the number of sheets S represents the first sheet of the job based on a count value by the counter 31 (Step S20).

If the first sheet is represented, the process advances to Step S21. Otherwise, the process advances to Step S27.

If the first sheet is represented (Yes in Step S20), a temperature sensor 244 measures a temperature of a heater (Step S21). The process advances to Step S22.

In Step S22, an expansion amount estimating section 34 reads a relationship (characteristic information) between temperatures of the heater 241 and expansion amounts of a pressure member from a table as described in FIG. 6. The process advances to Step S23.

In Step S23, the expansion amount estimating section 34 estimates an expansion amount of the pressure member based on the relationship between the temperatures of the heater 241 and the expansion amounts of the pressure member. The process advances to Step S24.

In Step S24, the fixing motor controller 246 sets a linear velocity of the pressure roller 242. The process advances to Step S25.

If the count value by the counter 31 does not represent the first sheet (No in Step S20), a timer 32 measures an interval from when a fixing belt 240 finishes a process for an m-th sheet S (m is a natural number) to when starting a process for an (m+1)-th sheet S. Alternatively, the timer 32 measures an interval from when the fixing belt 240 finishes an n-th job (n is a natural number) to when starting a process for an (n+1)-th job (Step S27).

If the interval is longer than or equal to a predetermined time (Yes in Step S27), the process proceeds to Step S21.

If the interval is less than the predetermined time (No in Step S27), the process proceeds to Step S28.

In Step S28, the fixing motor controller 246 determines a linear velocity of a fixing motor in a process for a k-th sheet based on a linear velocity history of the fixing motor 243 in a process for a (k−1)-th sheet before the counter 31 counts the k-th sheet (k is a natural number of 2 or more). The process advances to Step S25.

In Step S25, the fixing motor controller 246 performs control of driving the fixing motor 243 based on the interval. The process advances to Step S26.

In Step S26, the fixing motor controller 246 determines whether the job is finished based on the count value by the counter 31. If the job is not finished (No in Step S26), the process returns to Step S20. When the job is finished, the process ends (Yes in Step S26).

The embodiment of the present invention is described above with reference to the accompanying drawings. However, the present invention is not limited to the above-described embodiment and can be practiced in various ways within the scope without departing from the essence of the present invention. The drawings illustrate main elements of configuration schematically to facilitate understanding thereof. Aspects of the elements of configuration such as number illustrated in the drawings may differ in practice for the sake of convenience for drawing preparation. Further, each constituent element described in the above embodiment is merely an example that does not impose any particular limitations and may be altered in various ways as long as such alterations do not substantially deviate from the effects of the present invention.

### INDUSTRIAL APPLICABILITY

The present invention can be used in the field of image forming apparatuses.

1. An image forming apparatus, comprising:
a fixing member that fixes a toner image on a sheet;
a heater that heats the fixing member;
a pressure member that applies pressure to the fixing member to form a nip;
a fixing motor that drives the fixing member;
a temperature detector that measures a temperature of the heater;
an expansion amount estimating section that estimates an expansion amount based on a relationship between the temperature and an expansion amount of the pressure member; and
a controller that performs control of driving the fixing motor based on the expansion amount.

2. The image forming apparatus according to claim 1, further comprising:
a job-receiving section that receives a job;
a counter that counts a number of sheets processed according to the job received, wherein
the controller performs the control of driving the fixing motor before the counter counts 1.

3. The image forming apparatus according to claim 2, wherein the controller determines a linear velocity of the fixing motor in a process for a k-th sheet (k is a natural number of 2 or more) based on a linear velocity history of the fixing motor in a process for a (k−1)-th sheet before the counter counts the k-th sheet.

4. The image forming apparatus according to claim 1, wherein
the fixing member further comprises a timer that measures an interval from an end of a process for a m-th sheet (m is a natural number) to a start of a process for a (m+1)-th sheet, and
the controller performs the control of driving the fixing motor based on the interval.

5. The image forming apparatus according to claim 1, further comprising a timer that measures an interval from an end of the job for a n-th sheet (n is a natural number) to a start of a process of the job for a (n+1)-th sheet, wherein
the controller performs the control of driving the fixing motor based on the interval.

6. The image forming apparatus according to claim 1, further comprising a feeding section that stores the sheet, wherein
the controller completes the control of driving the fixing motor before the feeding section starts feeding the sheet.

7. The image forming apparatus according to claim 1, wherein the controller completes the control of driving the fixing motor at a latest before the sheet approaches the fixing member.

8. The image forming apparatus according to claim 1, further comprising
a conveyance roller that conveys the sheet to the fixing member, and
a conveyance motor that drives the conveyance roller, wherein
the controller performs the control based on the expansion amount to match a fixing linear velocity of the pressure member to a conveyance linear velocity of the conveyance roller.

9. The image forming apparatus according to claim 1, further comprising storage that stores a relationship between the temperature and a control amount of the fixing motor for each paper type, wherein
the controller corrects the driving the fixing motor based on the relationship.
